(19) United States
(12) Patent Application Publication
(10) Pub. No.: US 2023/0063776 A1
(43) Pub. Date: Mar. 2, 2023

(54) Variable-temperature Yarn with Continuous Sense of Cold and Manufacturing Method Thereof

(71) Applicant: Qingdao Zhenghengxiang Technology Co., LTD, Qiaodao City (CN)

(72) Inventors: Fengyan MOU, Qiaodao (CN); Fuzhi HE, Qiaodao (CN); Qiaoling WANG, Qiaodao (CN)

(21) Appl. No.: 17/814,642

(22) Filed: Jul. 25, 2022

(30) Foreign Application Priority Data
Sep. 2, 2021 (CN) 202111029081.4

(51) Int. Cl. D01F 1/10; D01F 8/14; D01F 8/06; D01F 8/12; B29C 48/00; B29C 48/05; B29C 48/21; B29C 48/84; B29C 48/28

(52) U.S. Cl. CPC D01F 1/10; D01F 8/14; D01F 8/06; D01F 8/12; B29C 48/022; B29C 48/05; B29C 48/21; B29C 48/845; B29C 48/28; B29C 48/0018; D10B 2321/021; D10B 2321/022; D10B 2331/04; D10B 2401/04; B29K 2995/0003; B29K 2067/003

(57) ABSTRACT

Disclosed are a variable-temperature yarn with a continuous sense of cold and a manufacturing method thereof. A fiber of the variable-temperature yarn with a continuous sense of cold comprises a skin part and a core part, wherein the core part is wrapped in the skin part and is made of a PCM or phase-change energy-storage wax, and a cross-sectional area of the PCM or phase-change energy-storage wax accounts for 5%-70% of a cross-sectional area of the fiber. More PCMs can be directly injected into a fiber core, so that a textile product has a stronger sense of cold, the sense of continuous cold of the product is greatly improved, the requirement of users for cold experience is better met, and the market blank is filled.

### CROSS REFERENCE OF RELATED APPLICATION

This is a non-provisional application that claims priority to a Chinese application, Chinese application number CN202111029081.4, filed Sep. 2, 2021, the entire contents of each of which are expressly incorporated herein by reference.

### BACKGROUND OF THE PRESENT INVENTION

### Field of Invention

The invention belongs to the technical field of textiles, and particularly relates to a variable-temperature yarn with a continuous sense of cold and a manufacturing method thereof.

### Description of Related Arts

Phase-change materials (PCMs) are substances that can change the state of substances and provide latent heat at a constant temperature. At present, when applied to similar products of variable-temperature yarns with a sense of cold, PCMs are fused in the yarns without a core-sheath structure. Only a small quantity of PCMs are fused in cold-sense yarns in the prior art. For example, less than 5% of PCMs can be fused in the yarns, which mainly has the following two defects: first, it is difficult to realize a long-filament structure; and second, even if the PCMs can be fused in yarns, the content of the PCMs in the yarns is less than 5%, which is too small to fulfill a satisfying somatosensory effect.

### SUMMARY OF THE PRESENT INVENTION

The objective of the invention is to provide a variable-temperature yarn with a continuous sense of cold and a manufacturing method thereof, which can overcome the above-mentioned defects of the prior art, and allow more PCMs to be fused in the yarn to fulfill a stronger sense of cold and a better use effect.

To fulfill the above objective, the invention adopts the following technical solution:

The invention provides a variable-temperature yarn with a continuous sense of cold, of which a fiber comprises a skin part and a core part, wherein the core part is wrapped in the skin part and is made of a PCM raw material, and a cross-sectional area of the PCM raw material accounts for 5%-70% of a cross-sectional area of the fiber.

Preferably, the skin part is made of polyethylene (PE), polyester (PET), polyamide (PA), or polypropylene (PP).

Preferably, the PCM raw material or phase-change energy-storage wax is a PCM with a melting point within 20° C.-39° C.

Preferably, the PCM or the phase-change energy-storage wax is a material that is blendable with PE, PET, PA or PP.

The invention provides a manufacturing method of the variable-temperature yarn with a continuous sense of cold, comprising the following steps:

Placing the PE and the PCM raw material into a hot melting device;

Wherein, the PE is placed in a heating screw, evenly melted by electrical heating, and then extruded into a metering pump under the action of the heating screw;

The PCM raw material is fully melted through a heating container provided with a stirring device;

Calculating an extrusion output of the PE and an extrusion output of the PCM raw material according to a thickness of the required yarn, and obtaining an accurate quantity of the PE and an accurate quantity of the PCM raw material by adjusting a rotational speed of the metering pump containing the PE and the PCM raw material;

Enabling, under the action of the metering pump, the PE and the PCM raw material to enter an assembly and then enter a spinneret in a melt flow direction, forming the skin part by the PE and forming the core part by the PCM raw material in the spinneret, extruding the skin part and the core part out of the spinneret as a whole, and then enabling the skin part and the core part to enter a winding unit after cooling and bundling by oiling; and

In the winding unit, winding and heating a filament extruded out of the spinneret on a first hot roller, and then enabling the heated filament to enter a second hot roller to be shaped; stretching the filament by means of a speed difference between the second hot roller and the first hot roller; and enabling the filament discharged out of the second hot roller to enter an interlacing device to improve yarn bundling cohesion, and then winding the filament on a paper bobbin on a winding head to form a yarn cake.

Preferably, the PCM raw material is a PCM or phase-change energy-storage wax.

Preferably, the PE is placed in the heating screw, evenly melted through electrical heating, and extruded into the metering pump at a pressure of 10 MPa under the action of the heating screw.

Preferably, the yarn cake is inspected and graded and is then packaged and delivered.

The invention has the following beneficial effects:

According to the variable-temperature yarn with a continuous sense of cold and the manufacturing method thereof, more PCM raw materials or further, more PCMs or phase-change energy-storage wax can be directly fused into a fiber core, so that a textile product has a stronger sense of cold, the continuous sense of cold of the product is greatly improved, the requirement of users for cold experience is better met, and the market blank is filled.

### BRIEF DESCRIPTION OF THE DRAWINGS

Here, accompanying drawings are used to provide a further understanding of the invention and constitute one part of the invention. Illustrative embodiments of the invention and descriptions thereof are merely used to explain the invention, and should not be construed as improper limitations of the invention. Wherein:

FIG. 1 is a structural diagram of a variable-temperature yarn with a continuous sense of cold according to the invention;

FIG. 2 is a partial sectional view of the variable-temperature yarn with a continuous sense of cold according to the invention;

FIG. 3 is a flow block diagram of a manufacturing method of the variable-temperature yarn with a continuous sense of cold according to the invention;

In the figures: 1, skin part; 2, core part.

### DETAILED DESCRIPTION OF THE PREFERRED EMBODIMENT

To gain a better understanding of the purposes, technical solutions and advantages of the invention, the technical solutions of the invention will be clearly and completely described below in conjunction with specific embodiments and corresponding drawings. Obviously, the embodiments in the following description are merely illustrative ones, and are not all possible ones of the invention. All other embodiments obtained by those ordinarily skilled in the art based on the following ones without creative labor should also fall within the protection scope of the invention.

The technical solutions of some embodiments of the invention will be described in detail below with reference to the accompanying drawings.

### Embodiment 1

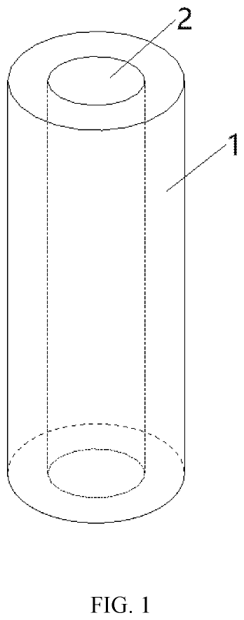

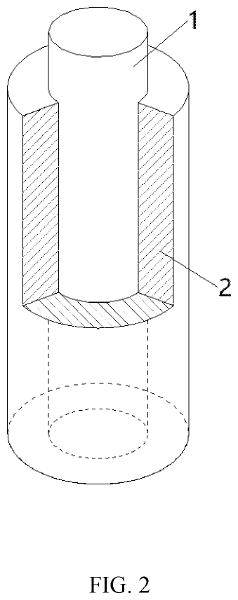

As shown in FIG. 1 and FIG. 2, a fiber of a variable-temperature yarn with a continuous sense of cold comprises a skin part 1 and a core part 2, wherein the core part 2 is wrapped in the skin part 1 and is made of a PCM raw material, and a cross-sectional area of the PCM raw material accounts for 5%-7% of a cross-sectional area of the fiber.

For example, the cross-sectional area of the PCM raw material or phase-change energy-storage wax accounts for 5%, 15%, 30%, 45%, 60% or 70% of the cross-sectional area of the fiber.

Preferably, the skin part 1 is made of PE, PET, PA or PP.

Preferably, the PCM raw material or the phase-change energy-storage wax is a PCM or phase-change energy-storage wax with a melting point within 20° C.-39° C. Fox example, the melting point of the PCM or the phase-change energy-storage wax may be 20° C., 25° C., 30° C., 35° C. or 39° C.

Preferably, the PCM or the phase-change energy-storage wax is a material that is blendable with PE, PET, PA or PP.

### Embodiment 2

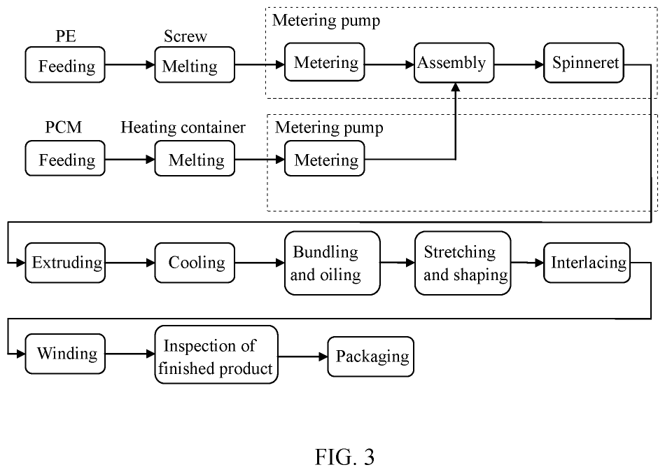

As shown in FIG. 3, a manufacturing method of the variable-temperature yarn with a continuous sense of cold comprises the following steps:

The PE and the PCM raw material are placed into a hot melting device;

Wherein, the PE is placed in a heating screw, evenly melted by electrical heating, and then extruded into a metering pump under the action of the heating screw;

The PCM raw material is fully melted through a heating container provided with a stirring device;

An extrusion output of the PE and an extrusion output of the PCM raw material are calculated according to the thickness of the desired yarn, and an accurate quantity of the PE and an accurate quantity of the PCM raw material are obtained by adjusting a rotational speed of the metering pump containing the PE and the PCM raw material;

The PE and the PCM raw material enter an assembly under the action of the metering pump and then enter a spinneret in a melt flow direction, the skin part 1 is formed by the PE and the core part 2 is formed by the PCM raw material in the spinneret, and the skin part 1 and the core part 2 are extruded out of the spinneret as a whole, and enter a winding unit after cooling and bundling by oiling; and

In the winding unit, a filament extruded out of the spinneret are wound and heated on a first hot roller, and then the heated filament enters to a second hot roller to be shaped; stretching the filament by means of a speed difference between the second hot roller and the first hot roller; and the filament discharged of the second hot roller enters an interlacing device to improve yarn bundling cohesion, and then the filament is wound on a paper bobbin on a winding head to form a yarn cake.

Preferably, the PCM raw material is a PCM or phase-change energy-storage wax.

Preferably, the PE is placed in the heating screw, evenly melted through electrical heating, and extruded into the metering pump at a pressure of 10 MPa under the action of the heating screw.

Preferably, the yarn cake is inspected and graded and is then packaged and delivered.

Preferably, the thickness of the required yarn may be 40 D, 75 D, 150 D or the like.

Preferably, the assembly is disposed in a main box.

Preferably, the metering pump containing the PE, the assembly and the spinneret are disposed in the main box.

Preferably, the main box is provided with an auxiliary box, and the metering pump containing the PCM raw material or the phase-change energy-storage wax is disposed in the auxiliary box.

According to the variable-temperature yarn with a continuous sense of cold manufacturing method thereof, the variable-temperature yarn with a continuous sense of cold is of a core-sheath (skin-core) structure, the surface layer is made of PE, and a PCM or phase-change energy-storage wax is injected into a cavity of a core. The PCM or the phase-change energy-storage wax can absorb heat of human bodies, so when the human bodies contact a fabric woven from the yarn manufactured through the manufacturing method of the variable-temperature yarn with a continuous sense of cold in the above embodiment, the PCM or the phase-change energy-storage wax in the core can absorb heat of hot bodies through the PE on the surface layer, which makes users feel cool all the time. By adoption of the manufacturing method of the variable-temperature yarn with a continuous sense of cold in the above embodiment, the PCM or the phase-change energy-storage wax can be injected into the core of the yarn to the maximum extent, so a textile product made of the yarn has a stronger sense of cold, and the purpose of a continuous sense of cold is realized.

The above description is merely used to explain several embodiments of the application, and is not intended to limit the application. Those skilled in the art can make different modifications and variations to the application. Any amendments, equivalent substitutions and improvements made based on the spirit and principle of the application should also fall within the scope of the claims of the application.

What is claimed is:

1. A variable-temperature yarn with a continuous sense of cold, a fiber of the variable-temperature yarn with a continuous sense of cold comprising a skin part and a core part, wherein the core part is wrapped in the skin part and is made of a PCM raw material, and a cross-sectional area of the PCM raw material accounts for 5%-70% of a cross-sectional area of the fiber.

2. The variable-temperature yarn with a continuous sense of cold according to claim 1, wherein the skin part is made of PE, PET, PA, or PP.

3. The variable-temperature yarn with a continuous sense of cold according to claim 1, wherein the PCM raw material or phase-change energy-storage wax is a PCM with a melting point within 20° C.-39° C.

4. The variable-temperature yarn with a continuous sense of cold according to claim 3, wherein the PCM or the phase-change energy-storage wax is a material that is blendable with PE, PET, PA or PP.

5. A manufacturing method of the variable-temperature yarn with a continuous sense of cold according to claim 4, comprising the following steps:
placing the PE and the PCM raw material into a hot melting device;
wherein, the PE is placed in a heating screw, evenly melted by electrical heating, and then extruded into a metering pump under the action of the heating screw;
the PCM raw material is fully melted through a heating container provided with a stirring device;
calculating an extrusion output of the PE and an extrusion output of the PCM raw material according to a thickness of the required yarn, and obtaining an accurate quantity of the PE and an accurate quantity of the PCM raw material by adjusting a rotational speed of the metering pump containing the PE and the PCM raw material;
enabling, under the action of the metering pump, the PE and the PCM raw material to enter an assembly and then enter a spinneret in a melt flow direction, forming the skin part by the PE and forming the core part by the PCM raw material in the spinneret, extruding the skin part and the core part out of the spinneret as a whole, and then enabling the skin part and the core part to enter a winding unit after cooling and bundling by oiling; and
in the winding unit, winding and heating a filament extruded out of the spinneret on a first hot roller, and then enabling the heated filament to enter a second hot roller to be shaped; stretching the filament by means of a speed difference between the second hot roller and the first hot roller; and enabling the filament discharged out of the second hot roller to enter an interlacing device to improve yarn bundling cohesion, and then winding the filament on a paper bobbin on a winding head to form a yarn cake.

6. The manufacturing method of the variable-temperature yarn with a continuous sense of cold according to claim 5, wherein the PCM raw material is a PCM or phase-change energy-storage wax.

7. The manufacturing method of the variable-temperature yarn with a continuous sense of cold according to claim 5, wherein the PE is placed in the heating screw, evenly melted through electrical heating, and extruded into the metering pump at a pressure of 10 MPa under the action of the heating screw.

8. The manufacturing method of variable-temperature yarn with a continuous sense of cold according to claim 5, wherein the yarn cake is inspected and graded and is then packaged and delivered.

9. The variable-temperature yarn with a continuous sense of cold according to claim 2, wherein the PCM raw material or phase-change energy-storage wax is a PCM with a melting point within 20° C.-39° C.

10. A manufacturing method of the variable-temperature yarn with a continuous sense of cold according to claim 3, comprising the following steps:
placing the PE and the PCM raw material into a hot melting device;
wherein, the PE is placed in a heating screw, evenly melted by electrical heating, and then extruded into a metering pump under the action of the heating screw;
the PCM raw material is fully melted through a heating container provided with a stirring device;
calculating an extrusion output of the PE and an extrusion output of the PCM raw material according to a thickness of the required yarn, and obtaining an accurate quantity of the PE and an accurate quantity of the PCM raw material by adjusting a rotational speed of the metering pump containing the PE and the PCM raw material;
enabling, under the action of the metering pump, the PE and the PCM raw material to enter an assembly and then enter a spinneret in a melt flow direction, forming the skin part by the PE and forming the core part by the PCM raw material in the spinneret, extruding the skin part and the core part out of the spinneret as a whole, and then enabling the skin part and the core part to enter a winding unit after cooling and bundling by oiling; and
in the winding unit, winding and heating a filament extruded out of the spinneret on a first hot roller, and then enabling the heated filament to enter a second hot roller to be shaped; stretching the filament by means of a speed difference between the second hot roller and the first hot roller; and enabling the filament discharged out of the second hot roller to enter an interlacing device to improve yarn bundling cohesion, and then winding the filament on a paper bobbin on a winding head to form a yarn cake.

11. The variable-temperature yarn with a continuous sense of cold according to claim 2, wherein the PCM raw material or phase-change energy-storage wax is a PCM with a melting point within 20° C.-39° C.

12. The variable-temperature yarn with a continuous sense of cold according to claim 11, wherein the PCM or the phase-change energy-storage wax is a material that is blendable with PE, PET, PA or PP.

13. A manufacturing method of the variable-temperature yarn with a continuous sense of cold according to claim 12, comprising the following steps:
placing the PE and the PCM raw material into a hot melting device;
wherein, the PE is placed in a heating screw, evenly melted by electrical heating, and then extruded into a metering pump under the action of the heating screw;
the PCM raw material is fully melted through a heating container provided with a stirring device;
calculating an extrusion output of the PE and an extrusion output of the PCM raw material according to a thickness of the required yarn, and obtaining an accurate quantity of the PE and an accurate quantity of the PCM raw material by adjusting a rotational speed of the metering pump containing the PE and the PCM raw material;
enabling, under the action of the metering pump, the PE and the PCM raw material to enter an assembly and then enter a spinneret in a melt flow direction, forming the skin part by the PE and forming the core part by the PCM raw material in the spinneret, extruding the skin part and the core part out of the spinneret as a whole, and then enabling the skin part and the core part to enter a winding unit after cooling and bundling by oiling; and
in the winding unit, winding and heating a filament extruded out of the spinneret on a first hot roller, and then enabling the heated filament to enter a second hot roller to be shaped; stretching the filament by means of a speed difference between the second hot roller and the first hot roller; and enabling the filament discharged out of the second hot roller to enter an interlacing device to improve yarn bundling cohesion, and then winding the filament on a paper bobbin on a winding head to form a yarn cake.

14. The variable-temperature yarn with a continuous sense of cold according to claim 13, wherein the skin part is made of PE, PET, PA, or PP.

15. The manufacturing method of the variable-temperature yarn with a continuous sense of cold according to claim 14, wherein the PE is placed in the heating screw, evenly melted through electrical heating, and extruded into the metering pump at a pressure of 10 MPa under the action of the heating screw.

16. The manufacturing method of variable-temperature yarn with a continuous sense of cold according to claim 14, wherein the yarn cake is inspected and graded and is then packaged and delivered.
